(19) United States
(12) Patent Application Publication
(10) Pub. No.: US 2011/0014837 A1
(43) Pub. Date: Jan. 20, 2011

(54) METHOD OF PRODUCING TEXTILE EMBLEMS WITH PRESSURE SENSITIVE ADHESIVE PROPERTIES

(76) Inventors: Navaid Baqai, Levittown, PA (US); Susan Ganz, Owings Mills, MD (US); Paul Weedlun, Ellicott City, MD (US)

Correspondence Address: OBER / KALER;C/O ROYAL W. CRAIG, 120 EAST BALTIMORE STREET, SUITE 800, BALTIMORE, MD, 21202, US

(21) Appl. No.: 12/839,791

(22) Filed: Jul. 20, 2010

Related U.S. Application Data
(63) Continuation of application No. 61/271,370, filed on Jul. 20, 2009.

(51) Int. Cl. B44C 1/165; B32B 37/12; B32B 27/12; C08K 5/101

(52) U.S. Cl. 442/151; 156/60; 156/327; 524/315

(57) ABSTRACT

A new device, pressure sensitive adhesive system for bonding textiles and a method for producing integrated textile emblems such as patches, emblems, emblems, labels and cut textile parts including wovens, knits and nonwoven structures made of both natural and or synthetic fibers incorporating a pressure sensitive adhesive. The resulting room temperature pressure sensitive-patch eliminates tedious and cost intensive sewing operations (embroidery) and or heat-sealing operations (heat transfers) to other textile products such as apparel and or accessories, headwear, crafts home furnishings and luggage. The room temperature pressure sensitive adhesive-patches comprise at least: 1) a top base layer which can be a knitted, woven or non-woven fabric sheet that is stitched, printed, embossed, etched, engraved, flocked or dyed to form a decorative element, and which may be cut into a desired shape; 2) a pressure-sensitive adhesive layer adhered to the top base layer that comprises an adhesive having good medium-to-high surface energy properties, is not water soluble and is of adequate thickness to provide a sustainable bond capable of surviving multiple washes to textile-based products such as apparel and or accessories, headwear, crafts home furnishings and luggage. The room temperature pressure sensitive-patches may be transferred by simple pressure, thereby eliminating the burden and expense of thermal or mechanical (stitched) bonding.

CROSS-REFERENCE TO RELATED APPLICATION(S)

The present application derives priority from U.S. Provisional Patent Application 61/271,370 filed Jul. 20, 2009.

### BACKGROUND OF THE INVENTION

1. Field of the Invention

The present invention relates to decorative transfers and, more particularly, to a method of producing room temperature-pressure transfers and emblems that may be applied to a variety of different indicia onto a variety of different substrates, and the room temperature-pressure transfers produced by the method. The particular room temperature-pressure transfers can be used as a decorative element such as emblems, text, logo graphics, reflective tape or numbers for adhesive application directly onto garments, apparel, and accessories, for identification, decoration, trademarking or otherwise embellishing the final product.

2. Description of the Background

Apparel and accessory manufacturers use various methods to apply decoration and identification to garments and textiles. Common technologies include silk-screening, screen-printing, sonic welding, direct embroidery and heat activated transfer.

Silk-screening of logos or emblems, though commonly used, does not result in a product that withstands repeated stretching, and is a complex and time-consuming process. In addition, the designs created by silk-screening are flat, lack texture, and do not withstand repeated industrial or home laundering. These deficiencies are avoided by embroidery; consequently, many companies prefer embroidery as their primary method for applying decoration and identification over silk-screening.

Ultrasonic welding is another method used to apply decoration and identification to garments and textiles. This process requires the creation of unique, expensive special dies for any design to be applied. Sonic welding allows texturing, but also requires chemical compounds that some companies find unacceptable, and that can result in a product that does not withstand stretching or repeated home and industrial laundering. Consequently, embroidery has instead become the primary method for applying decoration and identification in the industry.

Embroidery is typically performed by a machine that applies stitching of various colors and styles to fabric to create a design. Embroidered designs have a much greater aesthetic value, and withstand repeated home and industrial launderings. However, embroidery remains a complex, time-consuming process as well.

There have been a few attempts at providing emblems via heat transfers. U.S. Pat. No. 5,009,943 to Stahl discloses a method for producing a multi-colored emblem that may be ironed-on to garments to provide an embroidered appearance. This method entails laminating a material blank, cutting the laminated material to a specific design, embroidering about the periphery of the cut design, laminating the assembly onto a second material blank, and coating the underside with a thermal adhesive layer. The emblem can then be heat-sealed to a garment. Despite the ability to give a realistic embroidered look, thermally-bonded emblems still require additional processing steps and equipment to heat the emblem at application. Some fabrics such as nylon or polyester used in performance fabrics have extreme sensitivity to heat and thermal bonding is not always possible. In addition, thermal transfers typically have a greater rigidity or stiffness compared to the product to which they are being adhered. When applied, such emblems can decrease the comfort to the wearer of an apparel garment and change the drape characteristics of the product making it less visually appealing.

The apparel industry is gravitating toward quick-change low-inventory production, but the overhead required for the foregoing techniques renders them relatively slow and expensive. Consequently, embroiderers and other apparel customizers typically require substantial minimum-quantity orders, and bulk orders which are only justified when economics warrant the expenditure associated with setting up sewing or heatsealing decorations onto products. Apparel manufacturers would much prefer to customize articles in small batches in order to keep turnaround time and inventory at a minimum. For smaller quantity orders, however, sewing and heat-sealing decorations onto apparel, home furnishings or luggage is costly and time consuming. Individual consumers attempting to apply emblems must set-up to sew on the emblem or iron the emblem using a home iron. In a commercial environment industrial sewing equipment or heat presses would be necessary to set up and operate in production to decorate textile based items. Much of the production overhead required with the foregoing processes could be avoided with a room temperature-transfer pressure-applied emblem. However, there have been comparatively few attempts to provide room temperature-transfer emblems because the bond quality has in the past not been able to withstand wear and laundering.

For example, U.S. Pat. No. 5,635,001 to Mahn, Jr. issued Jun. 3, 1997 shows cloth transfers that include a cloth layer coated with a plastic layer which is, in turn, coated with a pressure sensitive adhesive layer. This patent teaches a method for using a pressure-sensitive adhesive to position transfer for sew down and the plastic layer is used to clear residual pressure-sensitive adhesive off the sewing needle. The minimum requirement of one millimeter is necessary because the pressure-sensitive is designed only for temporary placement and not intended as a permanent bond.

U.S. Pat. No. 6,753,050 to Dalvey et al. issued Jun. 22, 2004 shows a cold image transfer sheet for T-shirts including an image imparting layer and an adhesive layer. The adhesive layer permits transfer of an image to a substrate. The image transfer sheet comprises a base layer 12 (FIG. 1), a release layer 14 that overlays the base layer, a pressure-sensitive adhesive layer 16 (a variety are suggested including acrylic-based), polymer layer 18, primer layer 20 or optional second ink-receiving layer 22. An image or a portion of an image is imparted to one or more of the adhesive layer 16, polymer layer 18, primer layer 20 or optional second ink-receiving layer 22.

U.S. Pat. No. 4,880,678 to Goffi issued Nov. 14, 1989 shows a dry-cold transfer sheet suited for application to wood, that comprises a colored film adhering to a backing sheet with an interposition of a layer of release varnish. The colored film included 30-40% pigment, 1-4% of cycloaliphatic epoxy resin, from 15-35% of vinyl copolymer, from 1-4% of polyethylene wax.

U.S. Pat. No. 6,951,671 to Mukherjee et al. (P. H. Glatfelter Company) issued Oct. 4, 2005 shows an ink jet printable heat transfer material with cold release properties. The invention consists of multiple layers of coatings applied to a suitable substrate, typically paper. The first optional layer coating consists typically of a pigmented coating bound together with a synthetic or natural binder and is applied in sufficient quantity to level and densify the surface of a given substrate. The second coating is applied over the first and consists of a silicone coating with a controlled surface energy. The surface energy must be such that the subsequent aqueous coatings can be applied over top with good wetting and adhesion, but low enough for an easy removal from the heat transfer after cooling. A third or wash layer is applied over the silicone release layer so the coating does not come off during subsequent coating passes and during handling by the user. The wash layer consists of one or more thermoplastic polymers including ethylene acrylic acid, waxes, and other polymers along with dispersions of non-water soluble plasticizers and antioxidants.

Although stitched embroidery, heat transfer and welding is avoided in all of the foregoing cases, the resulting products are inferior in durability and cannot withstand repeated washing. It would be greatly advantageous to provide a method for adhesively applying textile emblems to apparel and or accessories, headwear, crafts home furnishings and luggage which requires no minimum garment quantity, minimal equipment, and which is less time consuming and labor intensive than affixing by sewing or heat-sealing.

### SUMMARY OF THE INVENTION

It is, therefore, an object of the present invention to provide a novel “room temperature” pressure adhesive capable of adhering textiles and fabrics and/or textiles and films together for purposes of seaming or attaching items such as appliqué bearing text, numbers, logos and other indicia for the apparel, accessory and other industries that serves as an embroidery, thermo-transfer film, silk screen or sublimated printing replacement. For purposes herein “room temperature” may include transfer temperatures within a range of from 60-100 degrees Fahrenheit, and more preferably encompasses a range of from 68° F. to 77° F.

It is another object to provide a room-temperature adhesive capable of bonding textile and fabrics or plastic transfer designed with high natural bond strength to withstand repeated laundering.

It is another object to provide a room-temperature adhesive to bond textiles and fabrics or create transfers that can be given out at meetings and ceremonies, and immediately applied at the event or at another convenient time in a rapid manner

It is another object to provide a room-temperature pressure-sensitive adhesive transfer that requires minimal pressure and is more suitable for production in smaller quantity ‘on demand” orders than sewing and heat-sealing seams and or decorations onto apparel, home furnishings, luggage or crafts.

These and other objects are achieved herein by an improved adhesive for bonding textiles, a method for producing an integrated textile emblem using the adhesive, and the emblem itself formed in accordance with the present method which is capable of adhering to textile based products as well as thermal transfers, and yet is less time consuming and labor intensive than previous methods known in the art, thereby avoiding any need for minimum product orders. The pressure-sensitive-adhesive-backed emblem described herein can be produced and applied to consumer textile based products such as apparel and accessories, crafts, home furnishings or luggage in accordance with the method described herein.

The adhesive is a solvent-based or water based pressure sensitive adhesive comprising modified acrylic compounds with minimal cross linking additives. The adhesive can be adhered directly to a textile emblem having a base layer of thermal plastic film or natural or synthetic textile fibers formed into a woven, knit or nonwoven sheet that is further decorated through several possible techniques or combinations thereof including dyeing, screen printing, sublimation printing, direct digital printing, embossing, etching, engraving, flocking, jacquard weaving, stitching, embroidery or appliquéing multiple layers of materials which are then cut out into decorative shapes or patterns.

Once the adhesive has been adhered to the textile emblem it forms a pressure-adhesive layer with the ability to bond to medium- to high-surface-energy substrates and establish a washable, sustainable bond. As used herein and throughout the appended claims, the term “washable” is intended to connote that the subject material is capable of withstanding at least 20-30 home laundering cycles without serious degradation of the bond.

In an intermediate state for transportation and storage purposes, a release liner made of coated paper or film is attached to the underside of the pressure-sensitive adhesive layer to protect and maintain the adhesive properties of the pressure sensitive adhesive prior to the application of the integrated emblem to a textile based textile based product such as apparel, home furnishings or luggage.

To apply the integrated textile emblem, the emblem is positioned over the textile-based target product to be decorated, and the release liner is removed. The emblem is then firmly pressed against the textile based product, thereby securely bonding the two together and creating a durable bonded decorated product.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a partial top plan view of the upper portion an integrated textile emblem capable of adhering to textile based products;

FIG. 2 is a cross sectional plan view of an integrated textile emblem capable of adhering to textile based products;

FIG. 3 is a cross sectional plan view of an integrated textile emblem capable of adhering to textile based products depicting the removal of the release paper or film from the product.

FIG. 4 is a cross sectional plan view of an integrated textile emblem adhered to the top surface of a textile based product.

FIG. 5 is overhead view of the integrated textile emblem shown in FIG. 1, adhered to a textile based product.

### DETAILED DESCRIPTION OF THE PREFERRED EMBODIMENT

The present invention is a pressure sensitive adhesive for securing textile products together, and a method of producing an integrated room temperature-pressure sensitive adhesive emblem bearing text, numbers, logos or other indicia for application to apparel and accessories, as well as the emblem constructed in accordance with the production process. For purposes herein “room temperature” may include transfer temperatures within a range of from 60-100 degrees Fahrenheit, and more preferably encompasses a range of from 68° F. to 77° F.

The construction utilizing the pressure sensitive adhesive ensures a high natural bond strength that withstands repeated laundering. The emblem is well-suited for application to any film, fabric or leather substrate, including coarser non-woven fabrics such as felt and fleece (“substrate” being herein defined as any film, leather or fabric, whether woven fabric or non-woven fabric, or any other flexible material used for apparel, signage, banners, pennants or similar, and “non-woven” being herein defined as any fabric substrate produced by processes other than weaving).

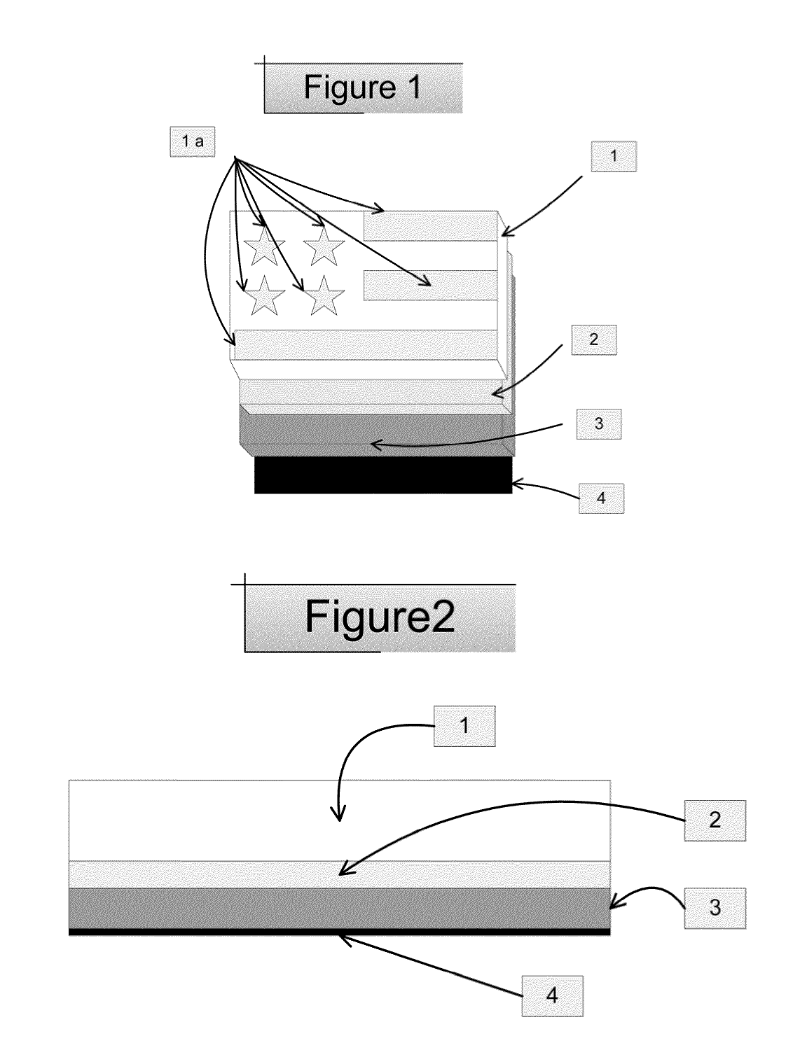

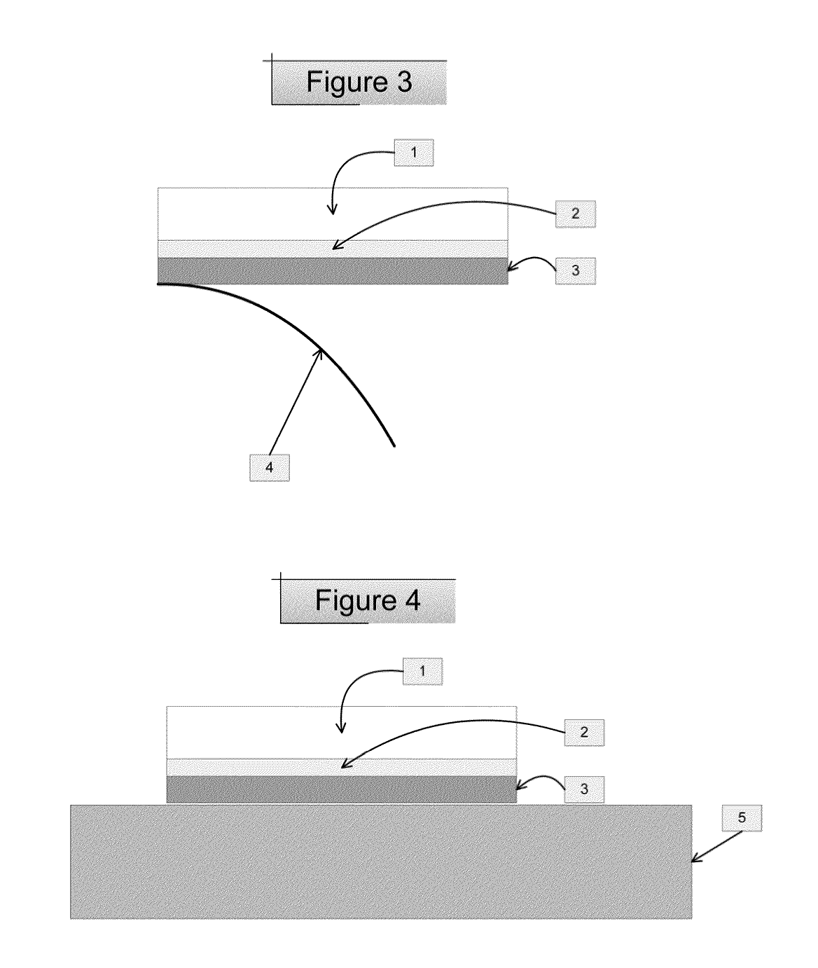

With combined reference to FIGS. 1 and 2, the multilayer emblem of the present invention generally includes a base layer (1) comprising natural or synthetic textile fibers formed in a woven, knit or nonwoven sheet, and which is decorated through several possible techniques or combinations thereof including dyeing, screen printing, sublimation printing, direct digital printing, embossing, etching, engraving, flocking, jacquard weaving, stitching, embroidery. In addition, the base layer (1) may comprise multiple appliquéd layers of materials cut out and adhered into decorative shapes or patterns. A pressure-sensitive acrylic adhesive layer (2) is then applied to the bottom of the base layer (1).

The pressure-adhesive layer (2) primarily comprises a solvent-based acrylic adhesive comprising modified acrylic-based compound with substantially no cross linking additives, and preferably without cross linkers. The preferred adhesive has the ability to bond to medium- to high-surface-energy substrates such as base layer (1) and thereby establish a washable, sustainable bond. Specifically, the pressure-adhesive layer (2) should be water-resistant and capable of withstanding repeated wash cycles (at least 20-30 home laundering cycles). It is deemed desirable that the adhesive layer (2) be an aggressive water-resistant type adhesive that provides an immediate tack to fabric materials upon applying pressure thereto, and which possesses stretch and recovery characteristics in order to survive the stresses created at the bonded interface caused by repeated washing and drying cycles. Optimally, the preferred adhesive is an acrylic pressure-sensitive adhesive with minimal (substantially none) cross-linkers designed for exceptionally high shear resistance.

Cross-linking requires the addition of cross-linking agent(s) to a base copolymer resin to form bonds that link one polymer chain to another. Acrylic adhesives customarily use cross-linking agents, such as isocyanate or epoxy, to give the acrylic polymer a 3D structure. There are two major crosslinking mechanisms for acrylic adhesives: free-radical copolymerization of multifunctional ethylenically unsaturated groups with the other monomers, and covalent or ionic crosslinking through the functional monomers. For free-radical copolymerization a variety of different materials have been used as crosslinking agents, e.g., polyfunctional acrylates, acetophenones, benzophenones, triazines, etc. The foregoing crosslinking agents, however, possess certain drawbacks which include one or more of the following: high volatility; incompatibility with certain polymer systems; generation of corrosive or toxic by-products; generation of undesirable color; requirement of a separate photoactive compound to initiate the crosslinking reaction; and high sensitivity to oxygen. For covalent or ionic crosslinking, the cross-linking agents are co-monomer(s) with pendant reactive functional groups. The choice of reactive group is important because it controls crosslinking efficiency, stability and adhesion properties. In addition, co-monomer selection has a significant effect on polymer cost, flexibility and UV resistance.

A suitable adhesive can be obtained by modification of Morstik™ 607 synthetic acrylic available through Rohm and Haas Company, Philadelphia, Pa.

Morstik® 607 is an acrylic, self cross-linking, pressure-sensitive polymeric adhesive generally comprising:

Acrylic polymer(s) 42.0-44.0%

Ethyl acetate 44.0-46.0%

Isopropyl alcohol 10.0-12.0%

The Acrylic polymer(s) further comprise approximately 85% 2-ethylhexylacrylate, 10% methylacrylate, 3% acrylic acid, and 2% vinyl acetate, yielding a poly(co-ethyl acrylate-2-ethylhexyl acrylate-2-hydroxyethyl methacrylate) base resin suitable for low-temperature self-crosslinking. The ratio of this product is 97% monomer to 3% acrylic acid. Other higher molecular weight acids such as metylacrylic acid could be utilized if desired physical properties can be achieved. Additionally, in Morstik® 607 an amount of polyisocyanate is added as a crosslinker for improved cohesion, and this may be an aliphatic isocyanate (hexamethylene diisocyanate (HDI) trimer), though other similar crosslinkers may be used. The polyisocyanate is present in minor amount (e.g., not more than about 15 wt-% of the Acrylic polymer(s)). The standard Morstik® 607 product has a ratio of monomer to crosslinker of 85% to 15%, versus the preferred embodiment of the present invention, which incorporates a ratio of monomer to crosslinker of substantially 97% to 3%. This marked increase in this ratio produces improved performance results in the applications described. The polyisocyanate forms an aqueous polymer system that crosslinks on drying under ambient conditions to form a crosslinked film or finish having improved adhesion, water resistance, solvent resistance, hardness, durability and weatherability. Unfortunately, such latent cross-linking functionality tends to lower tack and initial peel values, thus reducing the strength and suitability of the adhesive composition for the present application. Consequently, a modified Morstik® 607 formulation is used for the present application which minimizes (and preferably substantially eliminates) polyisocyanate or any other cross-linking agent. This modification results in a product that is better able to withstand repeated stretching when adhered surface to surface.

The pressure-adhesive layer (2) bonds to the decorative base layer (1) and to the target product to be decorated (not shown), which may be any textile based product such as apparel, home furnishings or luggage including fabric or leather substrates as defined above.

In addition, a release liner (3) may be adhered beneath the pressure-sensitive adhesive layer (2). The release liner (3) may be any suitable release-coated paper or film to protect and maintain the adhesive properties of the pressure sensitive adhesive layer (2) prior to application of the emblem to the target product. As shown in FIG. 3, the release liner (3) is simply peeled away and discarded prior to application of the emblem to a target product.

In accordance with the production process according to the present invention, the base layer (1) is bonded mechanically on the bottom, side opposite the decorated top of the base layer (1), to the pressure-sensitive adhesive layer (2). The release liner (3) is then adhered to the underside of the pressure-sensitive adhesive layer (2).

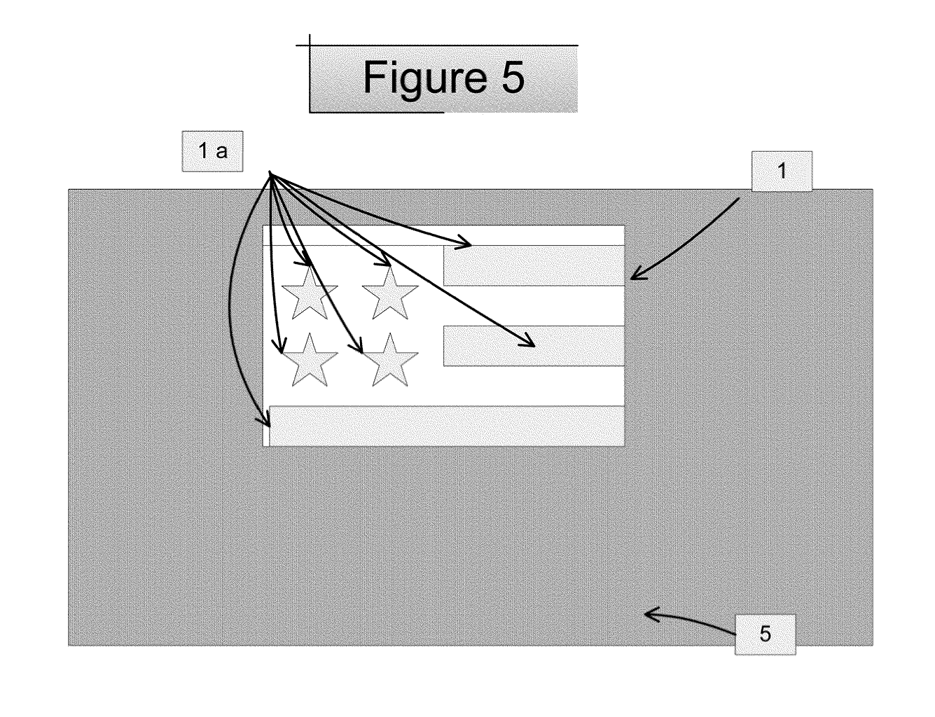

As shown in FIG. 4, it should be noted that the thickness of the pressure-adhesive layer (3) is critical to the achieving a satisfactory bond between the base layer (1) and the target consumer textile product (4). Most uncoated textile target products will have irregular surfaces, and there must be sufficient adhesive in the pressure-adhesive layer (2) to bond to the interstices or gaps between the surface of the base layer (1) and surface of the textile product (3). In the preferred embodiment, the thickness of the pressure sensitive adhesive layer (3) is a minimum of 0.003 inches.

To apply the integrated textile emblem, the release liner (3) is removed as seen in FIG. 3, and the emblem is positioned over the consumer textile product (4), as shown in FIG. 4. Given proper positioning, the textile emblem may be firmly pressed against the consumer textile product (4), as shown in FIG. 4, thereby securely bonding the two together and essentially creating a “decorated” embellishment on the surface of the consumer textile product (4) as shown in FIG. 5. Thus, with relative ease, apparel, home furnishings, luggage or craft can easily be decorated with a variety of embellishments.

The foregoing adhesive and emblem and process is especially suitable for use in decorating small quantities of garments, as well as large quantities. For smaller orders, the above process can be implemented by hand, but if the quantity of the order warrants, it is contemplated that auto-handling equipment (not shown) could be used to implement the process of applying pressure to affix the emblems. In either case, the above process eliminates the cost prohibitive and labor intensive sewing or heat-sealing operations required for affixing conventional embellishments. Decorators may now mass produce their textile products and use a variety of embellishments on multiple job orders and for many different products. This also creates the ability to immediately affix decorations in stores or at events creating immediate satisfaction of a customer or award recipient. In addition these decorations can be repositioned for a period of several minutes after placement if the user desires to change the placement of the decoration.

It will, of course, be understood that various changes may be made in the form, details, arrangement and proportions of the parts without departing from the scope of the invention which comprises the matter shown and described herein and set forth in the appended claims.

We claim:

1. A pressure sensitive adhesive that adheres to surfaces such as thermoplastic films and textiles within a temperature range of from 60-100 degrees Fahrenheit, comprising:
acrylic polymer within a range of from 42.0-44.0 weight %;
ethyl acetate within a range of from 44.0-46.0 weight %;
isopropyl alcohol within a range of from 10.0-12.0 weight %; and
substantially no cross linking additives.

2. The pressure sensitive adhesive according to claim 1, consisting of said acrylic polymer, ethyl acetate and isopropyl alcohol, excluding polyisocyanate and other cross-linking agents.

3. The pressure sensitive adhesive according to claim 1, consisting of said acrylic polymer, ethyl acetate and isopropyl alcohol in a ratio of acrylic polymer to crosslinker in excess of 97/3.

4. The pressure sensitive adhesive according to claim 1, consisting of said acrylic polymer, ethyl acetate and isopropyl alcohol in a ratio of acrylic polymer to crosslinker of substantially 97/3.

5. A room temperature pressure-applied emblem, comprising:
a decorative textile base layer;
a pressure sensitive adhesive layer applied to one surface of said decorative textile base layer to provide a wash durable, sustainable bond, said pressure sensitive adhesive layer further comprising a compound including acrylic polymer with substantially no polyisocyanate or other cross-linking agents.

6. The room temperature pressure-applied emblem according to claim 5, wherein said pressure sensitive adhesive layer adheres to surfaces within a temperature range of from 60-100 degrees Fahrenheit.

7. The room temperature pressure-applied emblem according to claim 6, wherein said pressure sensitive adhesive layer adheres to surfaces within a temperature range of from 68-77 degrees Fahrenheit.

8. The room temperature pressure-applied emblem according to claim 7, wherein said pressure sensitive adhesive layer further comprises the following constituents:
acrylic polymer within a range of from 42.0-44.0 weight %;
ethyl acetate within a range of from 44.0-46.0 weight %;
isopropyl alcohol within a range of from 10.0-12.0 weight %; and
substantially no cross linking additives.

9. The room temperature pressure-applied emblem according to claim 7, wherein said pressure sensitive adhesive layer further consists of said acrylic polymer, ethyl acetate and isopropyl alcohol, excluding polyisocyanate and other cross-linking agents.

10. The room temperature pressure-applied emblem according to claim 9, wherein said pressure sensitive adhesive layer consists of said acrylic polymer, ethyl acetate and isopropyl alcohol in a ratio of acrylic polymer to crosslinker in excess of 97/3.

11. The room temperature pressure-applied emblem according to claim 9, wherein said pressure sensitive adhesive layer consists of said acrylic polymer, ethyl acetate and isopropyl alcohol in a ratio of acrylic polymer to crosslinker of substantially 97/3.

12. The room temperature pressure-applied emblem according to claim 7, wherein said pressure sensitive adhesive layer is at least 0.003 inches thick.

13. A method of providing an integrated textile emblem capable of providing a durable bond adhering to textile based products such as apparel and or accessories, headwear, crafts, home furnishings and luggage, comprising the steps of:
(a) providing a previously manufactured textile emblem;
(b) laminating a pressure sensitive adhesive to the surface of a decorative textile product or emblem to provide a wash durable, sustainable bond; and
(c) adhering said emblem to by applying said adhesive layer to a textile based product in a manner to completely adhere the undersurface of said textile, fabric or emblem to said textile based product.

14. The method of providing an integrated textile emblem of claim 13, wherein said step of laminating a pressure sensitive adhesive, is a solvent based pressure sensitive adhesive made of modified acrylics that are water resistant and bond well to medium to high surface energy materials.

15. The method of providing an integrated textile emblem of claim 14, wherein said modified acrylics comprise an acrylic polymer and cross-linking agent in a ratio of acrylic polymer to cross linking agent of substantially 97/3.

16. The method of providing an integrated textile emblem of claim 13, wherein said step of laminating a pressure sensitive adhesive employs a pressure sensitive adhesive using as set forth in claim 9 mixed to yield predetermined elongation characteristics of a final products.

17. A room temperature pressure-applied emblem, comprising:
a decorative textile base layer;
a pressure sensitive adhesive applied to one surface of said decorative textile base layer, said pressure sensitive adhesive layer further comprising an acrylic monomer and not in excess of 3% cross-linking agents.

18. The room temperature pressure-applied emblem of claim 17, wherein said pressure sensitive adhesive layer further comprises an acrylic monomer and substantially no cross-linking agents.

19. The room temperature pressure-applied emblem according to claim 17, wherein said pressure sensitive adhesive layer is at least 0.003 inches thick.
